(19) United States
(12) Patent Application Publication
(10) Pub. No.: US 2015/0199039 A1
(43) Pub. Date: Jul. 16, 2015

(54) INPUT MEANS FOR A TOUCHSCREEN

(71) Applicant: Touchpac Holdings, LLC, New York, NY (US)

(72) Inventors: Sven Hofmann, Leipzig (DE); André Kreutzer, Mittweida (DE)

(73) Assignee: Touchpac Holdings, LLC, New York, NY (US)

(21) Appl. No.: 14/467,979

(22) Filed: Aug. 25, 2014

Related U.S. Application Data
(63) Continuation of application No. 14/126,754, now abandoned.
(60) Provisional application No. 61/497,629, filed on Jun. 16, 2011.

(30) Foreign Application Priority Data
Jun. 16, 2011 (EP) 11170233.8
May 11, 2012 (EP) 12167794.2

(51) Int. Cl. G06F 3/041

(52) U.S. Cl. CPC G06F 3/041

(57) ABSTRACT

In some embodiments, an input means is provided, comprising an electrically nonconductive substrate, an electrically conductive area that is present on the substrate, an electrical conductor track, a control unit for electrically interconnecting the electrical areas and an energy source. In some embodiments, a system is provided, comprising an input means and a touchscreen.

### RELATED APPLICATIONS

This application is a continuation of U.S. application Ser. No. 14/126,754, filed Dec. 16, 2013, which is a U.S. National Stage application based on International Application PCT/EP2012/061441, filed Jun. 15, 2012, which claims priority to U.S. Provisional Application No. 61/497,629, filed Jun. 16, 2011, European Application No. 12167794.2, filed May 11, 2012 and European Application No. 11170233.8, filed Jun. 16, 2011, all of which are incorporated herein by reference in their entireties.

The invention relates to an input means, comprising an electrically nonconductive substrate, an electrically conductive area that is present on the substrate, an electrical conductor track, a control unit for electrically interconnecting the electrical areas and an energy source. In addition, the invention relates to a system comprising an input means and a touchscreen.

In order to safeguard data or electrical devices against unauthorized access, numerous methods and techniques are described in the prior art. By way of example, access to a personal computer can be restricted with a code word in order to protect important data or to prevent the computer from being used by unauthorized persons. These code words are used in conjunction with encryption and identification check keys, which are used in order to establish secure message transmission between computers. Today, it is possible to install a program on the computer that encrypts sensitive data, as a result of which these data cannot be read by anyone who does not have the key for release. However, it is necessary for the key to be kept somewhere, and if this key is not complex then it is found.

Despite the constant development of new techniques, code words are still the most frequently used security tools; they are also the most misused and frequently the easiest to break for an unauthorized party. Code words are a type of security paradox. The best code words are the most difficult to guess: long and random. Unfortunately, they are also the most difficult to remember. Furthermore, most experts emphatically recommend using different code words for every e-mail, e-commerce or other account, and changing them regularly. As a result, most people either choose easily guessed code words or write them down, as a result of which they can be copied or stolen.

The average user therefore uses a plurality of preferably different passwords or code words. In the prior art, specific programs are described that store and manage code words. These programs provide a region in order to store long, complex or random code words and then encrypt them, as a result of which they cannot be stolen. Some of these “code word safes” even produce random code words for the user. However, they are frequently located on the personal hard disk and likewise require a code word in order to activate the software. A disadvantage of this is that a hacker can also obtain access to the program or to the storage location of the code words, however.

In addition, the prior art discloses that portable data storage media can be equipped with a chip, and the latter can be used to store data that are individual to a data storage medium or to a person. However, the data can be written to the embedded chip by a writing device located outside the data storage medium only via a suitable data communication link. In this context, it is known practice to provide contact areas on the outside of portable data storage media, which contact areas can be used to write data that are individual to a data storage medium or to a person (e.g. personalization data) to the chip of the data storage medium. Such data that are individual to a data storage medium or to a person relate to individualizing data for a person or for data storage medium configuration or the like that cannot already be loaded during the initialization of the data storage medium, since they are particularly not data that are independent of a data storage medium and/or a person that are suitable for a multiplicity of data storage media. To this end, the data that are individual to a data storage medium or to a person are written to the (already initialized) chip that is completely embedded in a plastic substrate via a contact array on the data storage medium.

Such contact arrays are visually conspicuous and, over the entire life of the data storage medium, provide basic access to the sensitive data in the chip, which access could be utilized for manipulation and spying out. Furthermore, they reduce the life of the chip, since external influences such as voltages can enter the chip directly. Similarly, the difficulty arises that electronically personalized—i.e. provided with personalization data—data storage media of this kind subsequently cannot readily be associated with visual personalization—i.e. visible, individualizing labeling or characterization—since the personalization data written to the chip can be read only with difficulty in the case of visual personalization.

By way of example, DE 195 00 925 A1 discloses a chip card for contactless data transmission that has one of its outer sides provided with contact areas, however, as a result of which the aforementioned disadvantages in connection with personalization arise in this case too.

In addition, the prior art describes the use of a one-time password. A one-time password (OTP) is an authentication method in which a password can be used only once for a session. This precludes an attacker from being able to intercept and reuse a password. The method is also called an alternating code method. In principle, there are two options for implementation in this case. Either pre-generated lists are used, which need to have been transmitted to the user beforehand via a secure channel. This is done for the TANs in the PIN/TAN method, for example. Alternatively, cryptographical hash functions are used for generating only briefly valid one-time passwords. Examples of these are SecurID or S/Key.

In order to make an input on a capacitive screen or touchscreen, specific input styluses are described in the prior art. The capacitive touch-sensitive screen detects the position of the input stylus, which changes the transcapacitance coupling between row and column electrodes. On a capacitive touch-sensitive screen, the input is often made by the finger(s) of a user. However, the finger of the user can conceal a portion of an operator control area of the capacitive touch-sensitive screen. On the basis of this, the finger of the user cannot be used to make a positionally precise input. In addition, a conventional input stylus for a capacitive touch-sensitive screen has an input stylus tip with a particular contact area for touching the capacitive touch-sensitive screen. However, the conventional input stylus is not capable of pointing exactly to a position that corresponds to a target pattern with a smaller area than the contact area.

A disadvantage of the input means disclosed in the prior art is that they are simple and hence do not allow complex and secure data inputs. Furthermore, the disclosed means cannot be used to make fast inputs.

It was an object of the invention to provide a means that allows input on a touchscreen and does not have the disadvantages or defects of the prior art.

The object is achieved by the independent claims. Advantageous embodiments can be found in the subclaims.

It was totally surprising that an input means, comprising at least
a. an electrically nonconductive substrate,
b. an electrically conductive area that is present on the substrate,
c. an electrical conductor track,
d. a control unit for electrically interconnecting areas according to b. and
e. an energy source,
   can be provided that does not have the disadvantages and defects of the prior art and allows transportable (mobile) input of data, for example code words, preferably one-time passwords. In the case of the inventive input means, at least one electrically conductive area is electrically connected to the control unit by means of at least one conductor track. The input means can advantageously be used to generate a code word by touching the means, this then being able to be forwarded to a receiver, for example to an evaluation unit of a device that contains a touchscreen. Consequently, a secure and mobile input means is provided that can be used to achieve firstly authorization/authentication but that can also be used secondly as a payment means and/or for identifying the payer. The input means can be used universally and can preferably be produced using mass production methods, which is in turn reflected in a low purchase price for the input means. Within the context of the invention, the terms “code”, “code word”, “password” are used analogously.

Within the context of the invention, data denote objects comprising characters or continuous functions that, on the basis of known or supposed conditions, present information, primarily for the purpose of processing and as a result thereof. The data or information are/is (machine) readable and editable and can be used for communication, interpretation or for processing. A person skilled in the art of computer science knows what the term “data” denotes. The terms data and information are used synonymously within the context of the invention. Within the context of the invention, an evaluation unit denotes electrical and electronic means that are present in a touchscreen or the electrical device that comprises the touchscreen and are used for the interpretation and processing of the inputs that are made via the touchscreen.

The input means comprises an electrically nonconductive substrate that holds at least one electrically conductive area. It may also be preferred for a plurality of electrically conductive areas in the form of one or more arrays to be arranged on the substrate, as a result of which an array or a plurality of arrays of electrically conductive areas that are not connected to one another is/are provided. Within the context of the invention, an array denotes an arrangement of electrically conductive areas on an electrically nonconductive substrate. These electrically conductive areas have terminal leads in the form of conductor runs or conductor tracks to a control unit. That is to say that all terminal leads are combined in the control unit, e.g. a controller chip. The areas are therefore electrically connected to one another only via the control unit, with there preferably being no direct electrical connection between the areas (apart from via the control unit).

By virtue of being brought into contact with a touchscreen, the input means can advantageously prompt a capacitive interaction that initiates an input on the touchscreen. This generates touch events on the touchscreen, which in turn initiate an event in the electrical device that contains the touchscreen.

In addition, it is preferred for a user to activate the input means and for a code to be transmitted via the electrically conductive areas of the input means. The code can be compared with an expected value, wherein the user is deemed authorized if a match can be found. It is thus possible to restrict access to an electrical device or to a program. It may also be advantageous for a plurality of codes that contain the target information to be connected sequentially, as a result of which it is possible for a larger volume of data to be transmitted to the evaluation unit of the touchscreen.

The substrate is preferably selected from the group comprising plastic, paper, card, wood-based material, film, composite material, glass, ceramic, printed circuit board material, textiles, leather or a combination of these. The substrate is particularly an electrically nonconductive substance that preferably has a low weight. It is possible to use transparent or opaque substrates. Preferred plastics include, in particular, PVC, PETG, PV, PETX and PE, with synthetic papers being preferred, in particular.

The substrate holds at least one electrically conductive area. It is also preferred for the electrically conductive areas to be arranged on the substrate individually, in pairs or in functional groups. Within the context of the invention, areas arranged individually, in pairs or as functional groups denote particularly an arrangement of areas that are used particularly to specifically alter the influence of the interaction with the touchscreen or the device that contains the touchscreen. By way of example, this includes the reduction, enlargement, production, swaying, alteration to and fro, displacement or progression of interactions that surprisingly initiate touch events, i.e. generate, erase and/or alter touch points. Within the context of the invention, erasure means particularly that the conditions for displaying a touch point are no longer satisfied, e.g. as a result of a threshold value being undershot. These touch events surprisingly make the interactions evaluatable for the touchscreen or the device that contains the touchscreen in the form of data and/or signals. The interaction between touchscreen and input means is controlled electronically under the same external influences (e.g. external positioning and distance are essentially not altered).

The shape of the area is arbitrary and may be fashioned in various designs. By way of example, there may be round, angular or oval areas or combinations, such as particularly annuluses, present on the substrate. It is also possible for complex geometric shapes to be implemented or for a plurality of individual areas to be combined with one another. It may be preferred for a substrate to hold a plurality of electrically conductive areas. Advantageously, the shape, orientation, number, alignment, distance and/or position of the areas can vary. Areas produced with a certain layout are also known to a person skilled in the art as structured areas. The areas are structured in the respective production method.

It may also be preferred for tactile, visual, audible or haptic elements to be put onto a layer of the input means or onto the electrically conductive area in order to provide a user with feedback. This can substantially simplify the operator control of the input means. By way of example, a visual element, such as an LED, may be arranged on the input means in order to signal to the user whether the input means is active (correct operator control), for example. That is to say that the visual element can be used as a state indicator, for example. In addition, it is possible to use such indicator elements in order to indicate the remaining battery life or in order to be able to easily estimate the remaining life of the input means.

The electrically conductive layer is preferably a metal layer, a layer containing metal particles, a layer containing electrically conductive particles, an electrically conductive polymer layer or a layer comprising at least one combination of these layers. In general, it is possible to use any material that is electrically conductive. Furthermore, it is also possible to use metallo-organic materials, comprising a compound of metal and carbon. Within the context of the invention, metals denote, in particular, chemical elements that, in contrast to nonmetals, are in the periodic system to the left of the diagonal dividing line, starting with the element beryllium (2nd group) through to polonium (16th group), and also alloys thereof and intermetallic compounds (comprising Laves phases, Heusler phases, Zintl phases, Hume-Rothery phases, NiTi, Co5, Nb3Sn or Ni3Al) with characteristic metal properties. Metals comprise, inter alia, aluminum, lead, chromium, iron, gold, indium, cobalt, copper, magnesium, manganese, molybdenum, sodium, nickel, silver, titanium, tungsten, zinc or tin. In addition, metal oxides such as indium tin oxide can be used. This is particularly advantageous because, although it is electrically conductive, it is also transparent. Hence, the effect achieved when using transparent metal oxides, particularly indium tin oxide, in combination with a transparent substrate is that no area on the touchscreen is visibly covered. By way of example, it is thus possible to display instructions to the user on the touchscreen while he is using the preferred input means. It is also possible to use alloys such as Ni/Au (Ni: nickel; Au: gold) or gold-plated copper. It is also possible for a plurality of metal layers to be combined.

In one preferred embodiment, a layer as cited previously is combined with a material that has a high relative permittivity. A person skilled in the art is aware that the term “dielectric constant” applies to permittivity, but can be regarded as outdated.

Within the context of the invention, polymers denote particularly a substance that is made up of a collective of macromolecules (polymer molecules) that are of chemically uniform structure but usually differ in terms of degree of polymerization, molar mass and chain length. The polymers are preferably electrically conductive. In the case of such polymer-uniform substances, all macromolecules are preferably of the same structure and differ only in terms of their chain length (degree of polymerization). Such polymers can be called polymer homologs. Polymers can be selected from the group comprising inorganic polymers, metallo-organic polymers, fully or partly aromatic polymers, homopolymers, copolymers, biopolymers, chemically modified polymers and/or synthetic polymers. With particular preference, polymers are selected from paraphenylene, polyacetylene, polypyrrole, polythiophene, polyaniline (PANI) and PE-DOT.

Electrically conductive substances are, furthermore, particularly carbon-black or graphite particles. Carbon black describes a manifestation of carbon that forms in the event of incomplete combustion or thermal cleavage of vaporous carbon-containing substances. Carbon black can be used in the form of powder or granulate. It is also possible to use carbon black preparations, for example as liquid, paste-like or solid carbon black solvent concentrates in which the carbon black is evenly dispersed. Depending on the manner of production and the raw material, carbon black can contain not only carbon but also hydrogen, nitrogen or oxygen. Carbon black exhibits an outstanding pigment property, and also insolubility in all solvents, resistance to most chemicals, light fastness, high color depth and color strength. Within the context of the invention, graphite denotes particularly a stable modification of carbon. On account of a layer-like structure, graphite is a good conductor.

The electrically conductive areas can advantageously be put on by means of additive methods such as printing methods, stamping methods, PVD and CVD methods, galvanic methods or subtractive methods such as laser patterning, brushing methods, milling methods, etc. Semi-additive methods such as etching methods may also be advantageous.

In one embodiment, the electrically conductive areas are put onto the substrate by means of a transfer method. For this, a film transfer method, particularly a thermotransfer method, is particularly preferred. A person skilled in the art is aware of such methods. Naturally, it is also possible to use all other methods for putting on an electrically conductive area.

In a further preferred embodiment of the invention, the input means has at least one layer and/or at least one further substrate ply. The substrate with the electrically conductive areas that have been put on may be covered or surrounded by at least one further layer or substrate ply. In this case, it is preferred for the further layer or substrate ply to comprise the same material as the substrate layer, with a different material also being able to be preferred. The further layer or the substrate ply can cover the electrically conductive areas and/or the substrate. This may be a top ply or a passe-partout, for example. The further layer or substrate ply is preferably made from paper, card, wood-based materials, composite materials, metal, laminates and/or plastics and may be printed or coated with a paint and/or lacquer layer. The further layer or substrate ply may also be an adhesive layer, a resin layer, a wax layer, a paper layer, a paint layer, a lacquer layer and/or a film. It is naturally also conceivable to put on combinations of the above. Within the context of the invention, the adhesive layer denotes particularly an electrically nonconductive adhesive that is put on such that it surrounds the electrically conductive areas. The further layer and the substrate ply allow a compact design for the input means, with the input means also being protected against external actions of force and soiling.

The control unit of the input means preferably comprises at least one digital and/or analog circuit. A digital circuit is preferably a microcontroller, but may also be an ASIC, an FPGA or a discrete digital circuit comprising logic gates, semiconductor components, electromechanical or mechanical components or a combination of these. The digital circuit is used for generating the data/codes to be transmitted and for converting the latter into digital or analog signals, which are forwarded to the electrically conductive areas (electrodes) either directly or via the analog circuit via the electrically conductive connections. An analog circuit is used for signal shaping and may contain a high-pass filter, a low-pass filter, an element for DC voltage decoupling, an operating point setting section (bias voltage) or a charge pump, for example. For each of the electrically conductive connections to a respective one of the electrically conductive areas, there preferably exist analog circuits of the same type, but there may also exist different designs of the analog circuit for the individual connections to the electrically conductive areas. It is also preferred for a mechanical arrangement to be put onto the control unit, said mechanical arrangement itself being controlled by a higher entity, such as a user, and opening and closing electrical jumpers between the conductor runs (relay design).

The electrically conductive areas, particularly the electrodes, may be designed to have any shape, geometry or width, height and depth.

It may be advantageous if the digital circuit of the control unit is an electronic, electromechanical or mechanical circuit.

The input means preferably comprises an energy source in order to safeguard independent operation of the input means. The energy source may be a battery, a storage battery, a solar cell, a piezo element, a capacitor or a combination of these, for example. The energy source is electrically connected to the control unit and supplies it with power. It may be preferred for the energy source to be rechargeable, interchangeable or replaceable by virtue of an external mains port. For this purpose, the energy source has appropriate connection ports. Advantageously, the energy source may be in the form of a solar cell, which uses artificial or natural light sources. It may also be preferred to use an “energy harvesting” method in order to supply power to the input means. By way of example, the power could be provided by the touchscreen that is in contact with the input means. It is also advantageously possible for the input means to be supplied with power by means of induction (e.g. an induction coil).

The input means preferably comprises at least one key and/or a switch. The input means may have a switch or a key arranged on it that jumpers contacts between the conductor tracks, i.e. an electrical connection can be set up. The switch or key can preferably be used to switch on the supply voltage, i.e. to set up a conductive connection between the energy source and the control unit. It is also possible for one or more keys or switches to be connected to the control unit as an input option, in order thereby to initiate associated functions on the control unit. By way of example, the key may be in the form of a snap-action disk that allows simple and fast operation.

The invention also relates to a system comprising an input means and a touchscreen, wherein the touchscreen is operatively connected to the input means. The device that contains the touchscreen is preferably selected from the group comprising smart phones, mobile phones, displays, tablet PCs, notebooks, touchpad devices, graphics tablets, televisions, PDAs, MP3 players and capacitive input devices. By way of example, a touchscreen may also be part of input devices. Touchscreens are also known as sensor screens. Such input devices are used in smart phones, PDAs, touch displays or notebooks, inter alia.

It was totally surprising that the input means can be used for a multiplicity of different touchscreens. Attempts have shown that capacitive touchscreens, in particular, are particularly well suited. In this case, an input means is operatively connected to the touchscreen. Within the context of the invention, operatively connected denotes particularly that the input means is at least intermittently connected or linked to the touchscreen such that a user can use the activated input means to initiate a touch event on the touchscreen.

Within the context of the invention, activation describes particularly an approach by the user to the input means and/or touching of the input means by the user and/or operation of a key or switch, without being limited thereto.

Touching and/or operation of a key or switch by the user connects the energy source, for example.

Alternatively, it may also be advantageous for the input means to have been or to be activated independently of the user, for example by virtue of a solar cell being used as an energy source in a switchless design. In this regard, it is preferred for the contact between the control unit and the energy source, e.g. a solar cell, to be closed. The energy source is available only when defined conditions are satisfied beforehand, e.g. a solar cell can be used as an energy source that provides a sufficient voltage only for a particular brightness.

In a further embodiment, it is preferred for the touchscreen to have visual, audible, tactile, haptic or mechanical positioning means that allow optimum positioning of the input means on the touchscreen. By way of example, an edge can be visually presented on the screen or the edge of the screen can be used as a means for positioning. The correct or incorrect positioning can be conveyed to the user easily by visual, audible, tactile or haptic means. In addition, the input initiated by the input means can be displayed on the touchscreen by means of a progress bar. This makes it possible to easily and quickly convey to the user how far the input has progressed.

The input means allows wireless communication/data transmission between mobile or stationary terminals having a touchscreen. The input means transmits data via the touchscreen to the terminal. The touchscreen is preferably actuated by means of capacitive coupling between the touchscreen and the input means. To this end, the input means is placed onto the touchscreen or brought into proximity thereof, as a result of which an electrical field is produced between touchscreen and input means. In this case, it is preferred for the input means to be activated before or after contact is made, as a result of which the placing of one or more fingers on the touchscreen is simulated and a touch input is produced on the terminal. The input on the terminal can be effected statically and/or sequentially.

An example may be cited for a preferred data rate as the following: for data transmission by means of the displacement of touch points, it would be possible to use 5×2 conductive areas, for example, with two respective conductive areas forming a functional group. After the input means has been brought into contact with the touchscreen, one touch event per functional group is initiated, and a respective touch point is generated. The input means is activated, whereupon the position of each touch point is altered in line with the data to be transmitted, and the respective touch point is moved to and fro and can therefore transmit the information “0” or “1” (“0” corresponds to one position and “1” corresponds to the other when the touch point is moved to and fro). For each functional group, it is accordingly possible for 1 bit to be coded. It is thus possible for successive information/data to be transmitted at intervals of time.

At a sampling rate for the touchscreen of 60 Hz, for example, the maximum data frequency to be transmitted, with due regard to the sampling theorem, is 30 Hz, and the maximum physical data rate is accordingly obtained as 5 bits*30 Hz=150 bits/s or 30 bits/s per functional group. From this, a person skilled in the art deduces the scalability of the data transmission by increasing or decreasing the functional groups. It is also possible to extend the digital state 0 or 1 and to allow further states or intermediate states. Hence, it is also possible to produce trinary (tristate) states, for example, which allows the data rate to be increased further.

For data transmission via the generation and erasure of touch points, the touch points can, by way of example, be arranged on the touchscreen in a defined coordinate system, e.g. a virtual 4×4 matrix. In this case, there would be 16 positions free for selection in order to arrange the touch points. Hence, 4368 different options for distributing 5 touch points over 16 positions are obtained (statistical principle

$$( \begin{matrix}16 \\ 5\end{matrix} )$$

“5 out of 16”, disregarding the order). This corresponds to a data depth of around 12 bits. The maximum physical data rate is accordingly obtained, with due regard to the sampling theorem, as 12 bits*30 Hz=360 bits/s.

The input means is arranged preferably in physical proximity to the touchscreen for the purpose of input. Within the context of the invention, a physical proximity denotes particularly that there is direct contact or indirect contact and the input means is in functional interaction with the touchscreen. This interaction can be achieved through various physical principles of operation or combinations thereof, e.g. capacitively, inductively, electromagnetically, electronically or mechanically. The respective interaction is dependent on the type of touchscreen that is specifically present, i.e. on the touchscreen technology. The function of the input means is preferably the initiation of at least one touch event on the touchscreen (i.e. preferably generating, erasing and/or altering touch points) so as to transmit specifically coded data, with coded data being evaluatable particularly in the context of an application. Within the context of the invention, a touch event denotes particularly initiation of an event on the touchscreen.

By way of example, a projected touch input by the input means on the touchscreen can transmit a one-time password that is generated in the input means to the touchscreen, this preferably being able to be used for authentication and/or authorization or for data input. The invention therefore also relates to the use of an input means for authentication, authorization and/or data input. In addition, it is preferred for the input means to be used for generating a one-time password, password or code.

By way of example, this allows the enabling of a device that has a touchscreen or of a program. It was totally surprising that the input means can preferably be used for applications in numerous areas of economic life. These include, by way of example, playing pieces, identification, customer cards, engine immobilizer, access authorization for car/bike sharing, entry authorization, random number generator, chip cards, car keys, keys, playing cards, collectable cards, goods logistics, goods tracking, digital classification systems, cataloging, digital file card system, admission, entry tickets, access to locked regions both really and virtually, virtual contents, marketing applications, customer loyalty, lotteries and competitions, member identity cards, season tickets, payment applications, certificates of authenticity, certificates, forgery safeguards, copy protections, signatures, delivery notes, articles within computer games, music/video/e-book downloads, bonus stamps/programs, device controllers or gift cards, without being limited thereto.

In one preferred embodiment, the input means can be operatively connected to the touchscreen such that it is merely placed onto the latter and contact between touchscreen and input means is produced particularly by gravitational force. However, it may also be preferred for the input means to be secured to or on the touchscreen by means of a temporary operative connection, as a result of which the substrate, with the electrically conductive areas, is in contact with or at least in physical proximity to the touchscreen and allows interaction with the touchscreen. It is preferred for the input means to be connected to the touchscreen, preferably reversibly, by means of form-fit, force-fit and/or integral connections. That is to say that the state prior to setup of the connection can be restored without the input means or the touchscreen or the environment thereof undergoing permanent changes. In a further embodiment, the input means is secured to the touchscreen on the basis of the sticky note principle (e.g. Post-it notes) or using other adhesives. In addition, it may be advantageous for just the conductive areas of the input means to be connected to or brought into preferred contact with the touchscreen.

It is also conceivable for further elements to be used for the temporary or permanent fixing of the input means to the touchscreen. All forms of adhesives (electrically conductive and electrically nonconductive) or glues, rubber bands, bands, insertion aids, clips, etc., are conceivable. Apparatuses, sleeves, etc., for the device that contains the touchscreen are also conceivable. This makes it possible to prevent the input means from slipping or shifting.

The input means may preferably be a card for paying for goods and services, or may be integrated in such a card. The card may be an electronic cash card or credit card or another card that can be used for payment transactions. A credit card is a card made from plastic (e.g. PVC) in the form of a check card (ISO 7810). On the front of the credit card, the card data are stamped in a raised manner (what is known as embossing). However, cards are also known that have no embossing. Such prepaid cards have a prepaid credit. On the back, each card bears the signature of the cardholder and frequently a card verification number (CVN). In addition, the back of the card holds a magnetic strip on which the card data are stored. Furthermore, chips may be fitted on the card. Advantageously, the cards have an EMV chip in order to achieve SEPA compatibility. The associated specification is called EMV (Europay, MasterCard, Visa). Furthermore, credit cards are also known that allow contactless payment on the basis of the ISO/IEC 14443 method. A further innovation, to increase security, is the hologram magnetic strip.

However, it may also be preferred for the input means to be in the form of a voluminous body, such as a playing piece, or to be integrated in or fitted to a playing piece. A person skilled in the art is aware that the input means can have its shape changed, as a result of which it cooperates with and matches itself to the specific shape of a playing piece in optimum fashion. Hence, the input means can be fitted essentially to any desired point on the playing piece, as a result of which the electrodes are preferably arranged on the base of the playing piece.

In one embodiment, the input means may be integrated in a greetings card. This allows the greetings card to interact with a touchscreen and to be extended above the limited content of the card.

The input means is preferably integrated in the card or the voluminous body such that the original function of the card or of the body is not influenced. Instead, the card can be used as an additional means for generating a code or in the course of the PIN/TAN method for authorization/authentication. This allows particularly the security of the electronic payment transaction to be substantially increased, since besides the security features of the card there is now a further security barrier inserted that renders copying of the card impossible. Besides the original security barriers, a user must also generate a one-time password, which is possible only with the input means on the card, however. This allows a high security standard to be set up. This is of high relevance particularly for payments on the Internet.

The input means can physically interact with a smart phone or an electrical device having a touchscreen and can generate a code for authentication, which allows secure handling of a payment transaction on a web site. The physical interaction between input means and touchscreen takes place bidirectionally, while the data transmission is preferably effected unidirectionally, i.e. preferably just in one direction, namely preferably from the input means to the touchscreen.

The input means may be in the form of part of such a card, and it may also be in the form of an independent card for paying for goods and services. The input means can preferably be used to generate a password that effects authorization and/or authentication. By way of example, the input means can identify a consumer and/or enable a payment.

The invention also relates to a method for inputting data on a touchscreen comprising
a. an input means comprising at least
   i. an electrically nonconductive substrate,
   ii. an electrically conductive area that is present on the substrate,
   iii. an electrical conductor track,
   iv. a control unit and
   v. an energy source,
   vi. and/or a key and/or a switch,
   wherein at least one electrically conductive area is electrically connected to the control unit by means of at least one conductor track,
b. and a touchscreen,
   wherein the input means is operatively connected to the touchscreen, as a result of which the areas begin to interact with the touchscreen, as a result of which, for electrically activated areas, influencing of touch events is achieved and data input on the touchscreen is attained. These can now be interpreted, decoded or processed further in another way. In this case, the input data may advantageously be randomly produced or determined data. That is to say that the input means can advantageously generate a one-time password or password, this already having been determined beforehand and being compared with an expected value. In addition, however, it is preferred for the input means to generate a password that is random. In this case, the password has parameters that allow explicit authentication.

The data input can preferably take place on the entire area of the touchscreen, with the data input being able to differ by virtue of locality, arrangement and/or number of points, preferably as follows:
The number of points may be either fixed or variable.
Activation of one or more areas.

Within the context of the invention, a data input denotes particularly that a touch event is activated and deactivated by means of one or more area(s) (e.g. capacitive coupling on/off or more/less), with preferably no movement taking place between touchscreen and input means. Particularly when the areas are in the form of an annulus, just a reduction in the activated area of the ring can prompt no further touch event to be initiated, whereas an enlargement of the activated area prompts initiation to be achieved (capacitive coupling more/less).

It may also be preferred for the data input on the touchscreen to be effected statically and/or dynamically. In particular, a static input denotes precisely one state from a combination of the touch points within the context of a snapshot. A chronology of various static states characterizes a dynamic input, in particular.

Between input means and device that has the touchscreen, an arrangement may have been made that describes the details relating to the chronology for a dynamic input. It is also preferred for one or more electrically conductive areas of the input means to be used as a clock generator for the data transmission, the remaining electrically conductive areas being used for transmitting the actual data.

The use of a plurality of electrically conductive areas can be used for transmitting a parallel data stream.

It may also be preferred for the areas for producing the touch events to be moved or influenced.

It is also preferred for the data produced by the input means to be able to be associated with a data record in a data processing system and for the data record to remain constant. In one preferred embodiment, the data produced by the input means are associated with a data record in a data processing system, with the data record changing. This can occur as a result of use of the input means or of the code(s) generated by the input means and/or as a result of time, for example, without being limited thereto.

Advantageously, the input means can be used such that the input means in conjunction with a touchscreen can be associated with or initiates an action by a data processing system by means of the influencing of one or more touch events or the generation of a code or one-time password. This action pertains particularly to non-networked data processing systems and particularly preferably to networked data processing systems.

The input means or the system comprising the input means and the touchscreen can be used to initiate associated events or actions on a device that contains a touchscreen. The associated events or actions are typical of a system or based on a system and application.

The invention will be explained below with reference to examples and figures but without being limited thereto. In the figures:

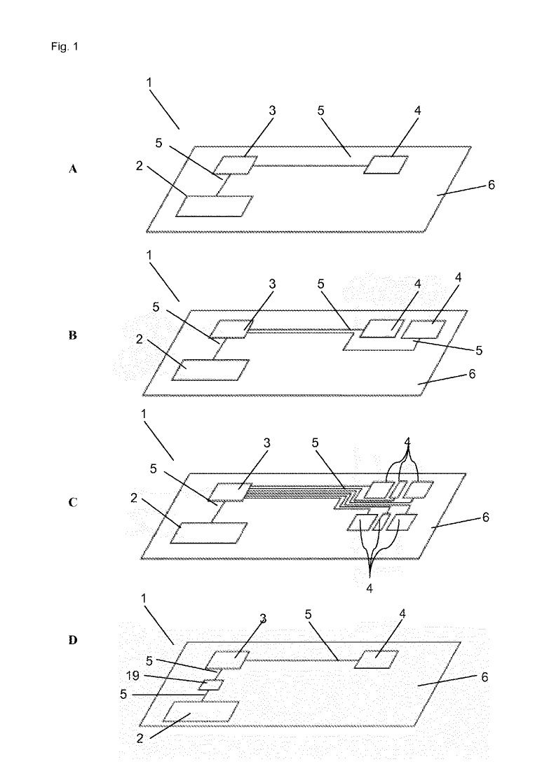

FIGS. 1A-D show the design of an input means,

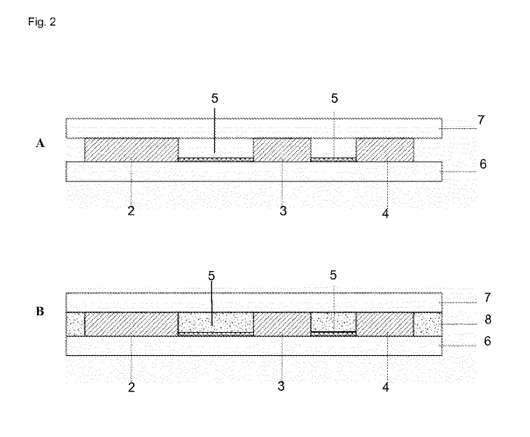

FIGS. 2A, B show a sectional illustration of an input means,

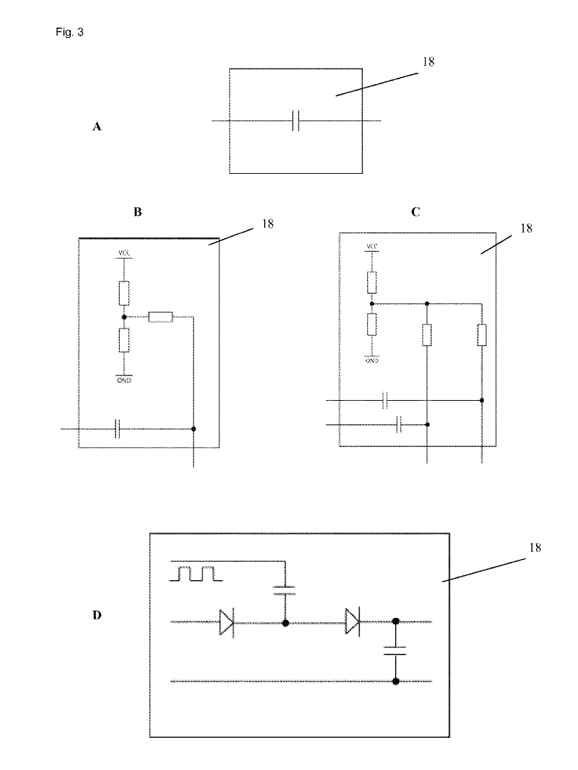

FIGS. 3A-D show analog circuits of the control unit,

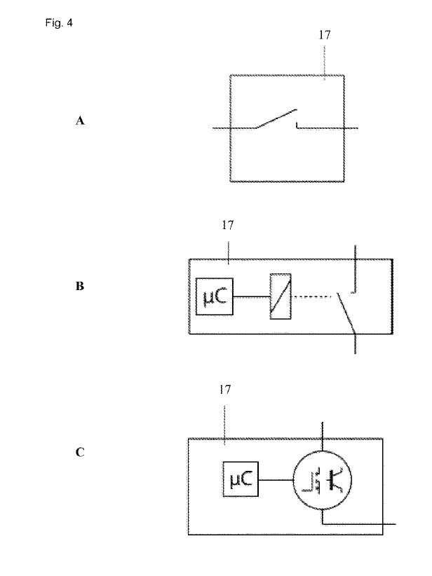

FIGS. 4A-C show digital circuits of the control unit,

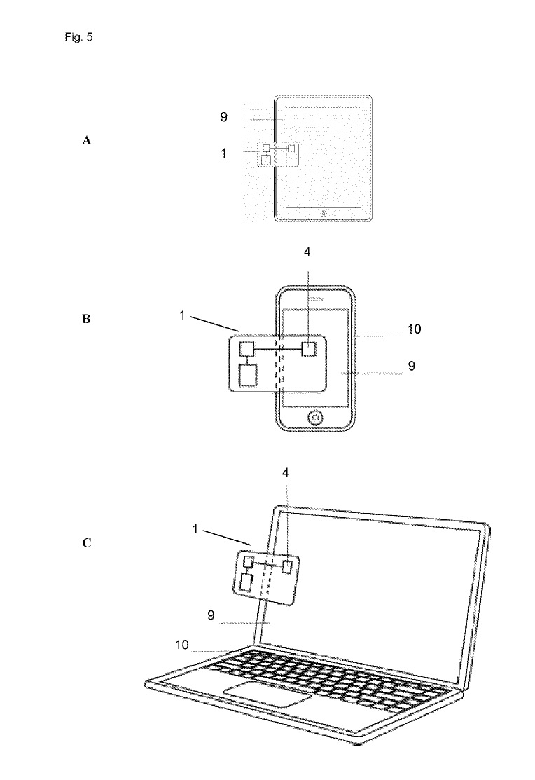

FIGS. 5A-C show interaction between an input means and a touchscreen,

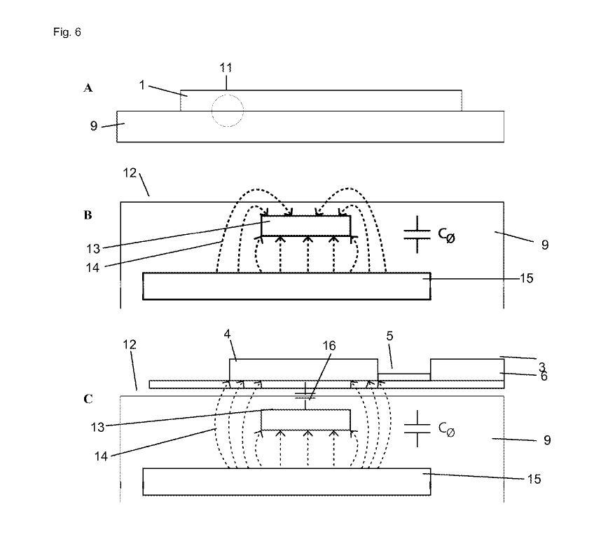

FIGS. 6A-C show operative connection between an input means and a touchscreen,

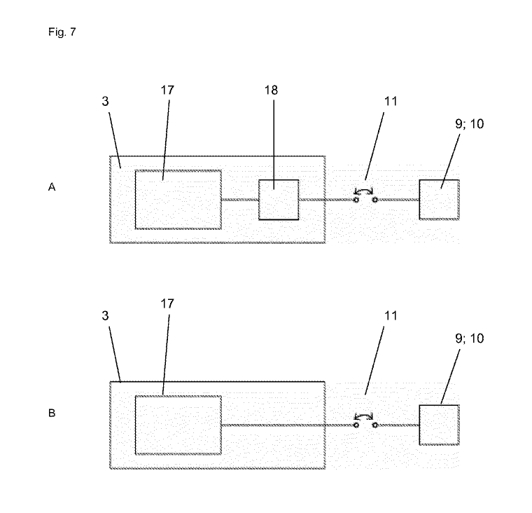

FIGS. 7A, B show input means with a digital/analog circuit,

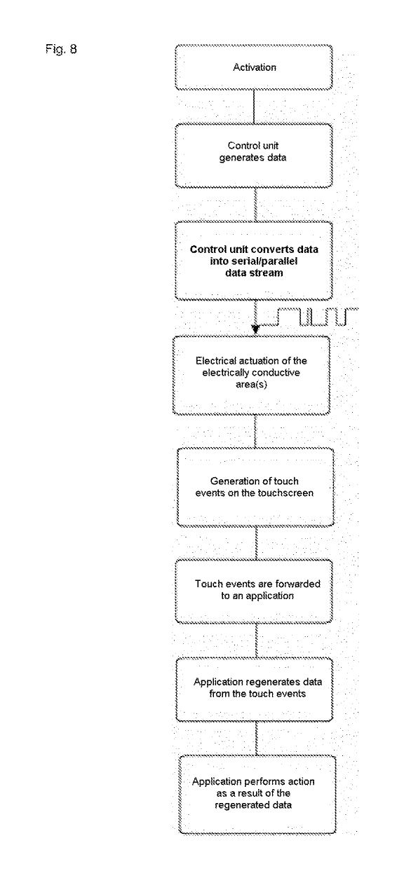

FIG. 8 shows a block diagram of data transmission to a touchscreen by means of input means,

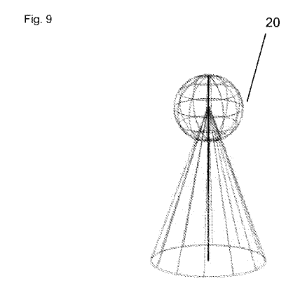

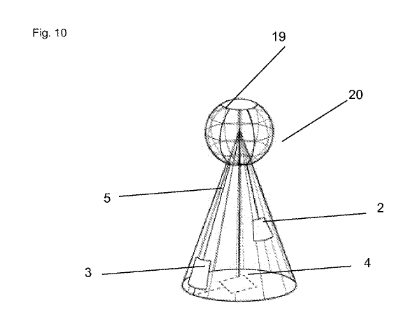

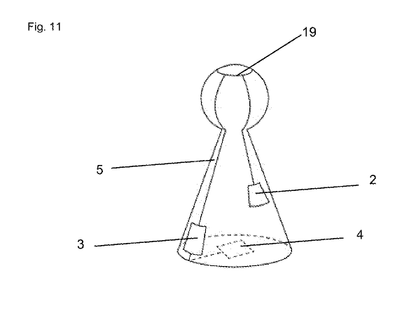

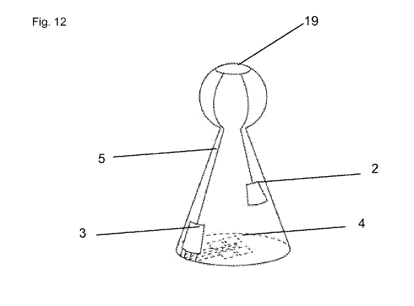

FIGS. 9-12 show preferred embodiments of the input means,

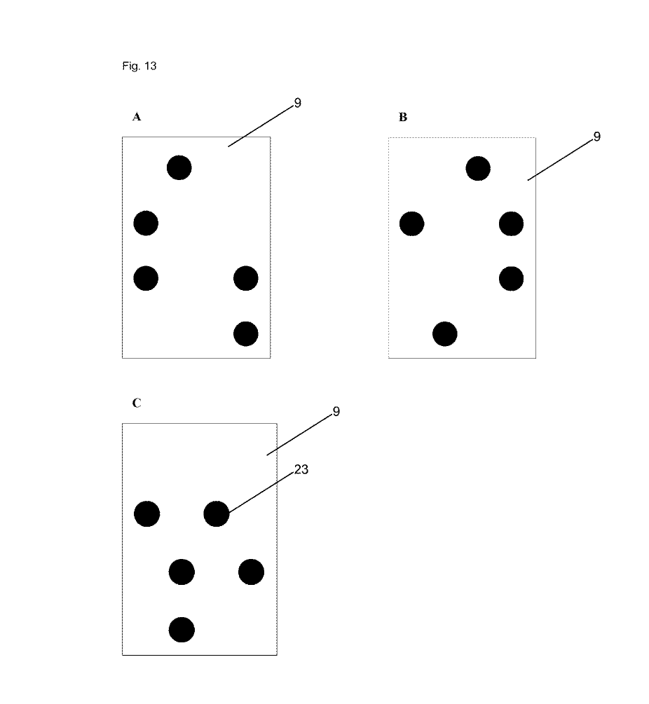

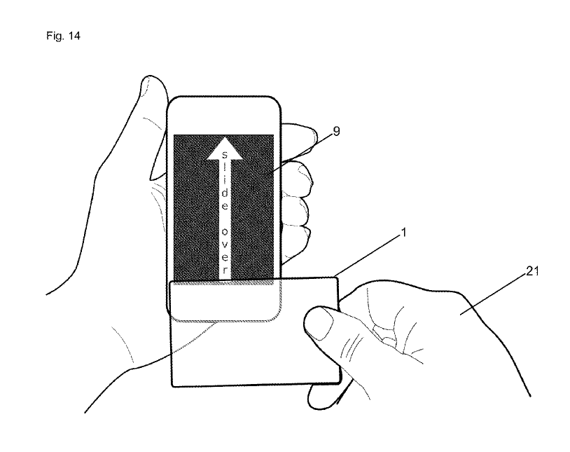

FIG. 13 and FIG. 14 show dynamic/static input,

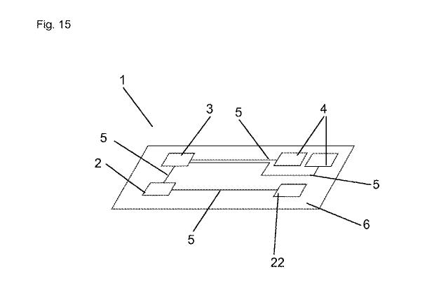

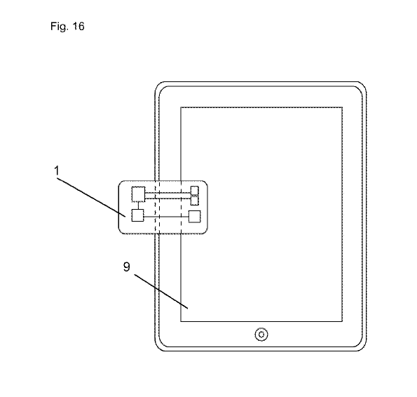

FIGS. 15 and 16 show an exemplary embodiment of an input means with a solar cell.

FIGS. 1A-D show a design of a preferred input means, FIGS. 2A, B show a sectional illustration of an input means 1, FIGS. 3A-D show analog circuits of the control unit and FIGS. 4A-C show digital circuits of the control unit. The input means 1 preferably has an electrically nonconductive substrate 6 that is made from plastic, for example. The substrate 6 holds at least one electrically conductive area 4 that is connected to a control unit 3 by means of an electrically conductive conductor track 5. The electrically conductive area 4 may be particularly a metal layer, a layer containing metal particles, a layer containing electrically conductive particles or an electrically conductive polymer layer. Essentially, any electrically conductive material can be used as area 4. The conductor track 5 that connects the area 4 to the control unit 3 is likewise made from an electrically conductive material, for example from the same material as the area 4. It may also be preferred for a plurality of electrically conductive areas 4 to be put on the substrate 6 (see FIGS. 1B, C). The electrically conductive areas 4 are connected to the control unit 3 by means of conductor tracks 5. The control unit 3 is in turn connected to an energy source 2, for example a battery, a storage battery, a solar cell, a piezo element, a capacitor or a combination of these. The energy source may also be an “energy harvesting” energy source, as a result of which the input means 1 obtains its power by drawing power from a further energy source. Within the context of the invention, the terms energy supply and energy source can be used in equal measure and denote particularly a means that supplies the input means with electric power. By way of example, this may be illuminating energy from a touchscreen 9. The input means 1 may also have ports in order to connect it to a mains port, for example. Wireless charging techniques for charging the energy source 2 of the input means 1 may also be preferred. In one particularly preferred design of the input means 1 (see FIG. 1D), a pushbutton switch 19 or switch is used to close the normally open electrical connection between the energy source 2 and the control unit 3, as a result of which the control unit 3 is activated in order to generate data and to transmit said data to a device 10 that has a touchscreen.

The input means 1 has at least one electrically conductive area 4 that has been put onto an electrically nonconductive substrate 6. The area 4 can be put onto the substrate 6 by means of additive or subtractive methods that are known to a person skilled in the art, such as printing or etching. The area 4 is connected to the control unit 3 by means of an electrically conductive conductor track 5, said control unit in turn being connected up to the energy source 2.

In one embodiment, the input means 1 may have not only the substrate 6 but also a further layer or ply that is in the form of an intermediate layer 8 (see FIG. 2B) or top ply 7. The top ply 7 may comprise the same electrically nonconductive material as the substrate 6 and is preferably used for protecting the elements of the input means 1 against actions of force or contaminations. Alternatively, the top ply 7 may also be a lacquer layer or film layer that has been applied to at least one intermediate ply 8, for example, and can have motifs or characters printed onto it. The intermediate ply 8 may be a filler material. The filler material used may be an adhesive layer, preferably an electrically nonconductive adhesive layer, for example. Alternatively, it is also possible for a passe-partout to be integrated into the input means 1 as an intermediate ply 8. The intermediate ply can be used to stabilize the elements of the input means 1 and likewise to protect them against actions of force. In addition, the at least one intermediate ply 8 ensures a homogeneous, uniform and even product design that can be refined further by further method steps, e.g. printing.

It may be advantageous for the digital signals, which are generated particularly in the digital circuit 17 of the control unit 3, to be routed via an analog circuit and the conductor track 5 to the electrically conductive areas 4 in order to change the signal properties such that the capacitive coupling between the conductive areas 4 of the input means 1 and the electrodes of the touchscreen 9 is amplified or attenuated. By way of example, the analog circuit may contain a signal amplifier, a signal attenuator, a high-pass filter, a low-pass filter, an operating point setting section, a DC voltage decoupling section, a signal termination section or a combination of such elements, without being limited thereto. A particularly preferred circuit of a signal amplifier is the charge pump. A person skilled in the art is aware of appropriate analog circuits for the listed elements. For each of the electrically conductive connections to a respective one of the electrically conductive areas 4, there preferably exist analog circuits of the same type, but there may also exist different designs of the analog circuit for the individual connections to the electrically conductive areas.

The digital circuit 17 is used for generating the data/codes to be transmitted and for converting them into digital or analog signals that are forwarded to the electrically conductive area 4 either directly or via the analog circuit 18 via the electrically conductive connection 5. With particular preference, the digital circuit 17 generates a plurality of electrical signals that are each forwarded to a respective electrically conductive area 4 individually using an analog circuit 18 or directly using a respective electrically conductive connection 5. A digital circuit 17 is preferably a microcontroller, but may also be an ASIC, an FPGA or a discrete digital circuit comprising logic gates, semiconductor components, electromechanical or mechanical components or a combination of these.

FIGS. 5A-C and FIG. 15 show a physical interaction between an input means 1 and a touchscreen 9. The input means 1 can physically interact with a touchscreen 9. The touchscreen 9 is preferably part of an electrical device 10, including smart phones, mobile phones, displays, tablet PCs, notebooks, touchpad devices, graphics tablets, televisions, PDAs, MP3 players and capacitive input devices. A touchscreen 9 may also be part of an input device. The input means 1 is brought into contact with the touchscreen 9. Within the context of the invention, this can mean that the input means 1 makes contact with the touchscreen 9 or is brought into proximity thereof, as a result of which it is possible to attain an effect on the touchscreen 9 or on the device 10 that has the touchscreen when the input means has been activated. Within the context of the invention, bringing into contact means that there is preferably no free space particularly between the input means 1 and the touchscreen 9. That is to say that the input means 1 is preferably in physical contact with the touchscreen 9. However, it may also be preferred for there to be no direct contact between the input means 1 and the touchscreen 9, but rather for there to be only a proximity that is sufficient to initiate an input on the touchscreen 9 when the input means is activated. For a proximity, there is a preferred distance of particularly 0 cm to 2 cm between input means 1 and touchscreen 9.

The input means 1 can interact with the touchscreen 9 in any orientation. By way of example, it can have its full area placed onto the touchscreen 9 or just part of it. Advantageously, however, it is brought into contact with the touchscreen 9 such that at least one electrically conductive area 4 is in contact with the touchscreen 9. The touchscreen 9 may also be part of a laptop or computer. The interaction of the input means 1 with the touchscreen 9 allows a data input to be made that is used for authorization or authentication, for example.

If the input means 1 comprises a solar cell, it may be advantageous for the input means 1 to be brought into contact with the touchscreen 9 in a particular orientation, as a result of which the solar cell can use the radiation energy from the touchscreen 9 to obtain power.

FIGS. 6A-C show an operative connection between an input means 1 and a touchscreen 9. Within the context of the invention, an operative connection 11 denotes a connection between the input element 1 and the touchscreen 9, as a result of which it is possible for the influencing of touch events by the input means 1 to be produced on the touchscreen 9, said influencing being able to be evaluated by an evaluation unit of the touchscreen 9 and/or by the device 10 that has the touchscreen. In the simplest sense, operatively connected means particularly that something is at least intermittently mechanically connected to one another. In addition, it may be connected—e.g. electronically —such that power and/or information is/are transmitted (for example without there being a mechanical connection); that is to say that two elements are arranged or linked to one another such that the desired effect is implemented. This interaction is dependent on the mode of action of the touchscreen 9 and can be achieved through various physical principles of operation or combinations thereof, e.g. capacitively, inductively, electromagnetically or electronically. Power can be transmitted from the touchscreen to the input means particularly when the input means has appropriate components (such as a solar cell, FIG. 15) and the radiation emitted by the touchscreen is used. The solar cell 22 may be arranged on the input means 1 on the side that points in the direction of the device and on the averted side. Depending on what power is used (power from a screen or from a radiation source in the environment), it is advantageous if the solar cell 22 has the appropriate orientation and is aligned accordingly. FIG. 6B shows a mode of action of a capacitive touchscreen 9 by way of example. In this case, there are electrical field lines 14 between the sensor lines 13 (or sensor electrodes) and the driver lines 15 (or driver electrodes) of the touchscreen 9. The contact between the input means 1, to be more precise the electrically conductive areas 4 of the input means 1, and the surface of the touchscreen 12 results in a change in the electrical field lines 14 between the driver line 15 and the sensor line 13 and in the capacitive coupling 16. The influencing of the electrical field lines 14 is brought about essentially by the electrically conductive areas 4 that are present on the input means and by the actuation of said electrically conductive areas. Further elements of the input means 1, such as conductor tracks 5 or control unit 3, advantageously have no effect on the touchscreen 9, or the electrical field lines 14. The change in the electrical field lines 14 can be evaluated and processed by an evaluation unit of the touchscreen 9 and/or by the device 10 that has the touchscreen.

FIGS. 7A, B show a basic illustration of the functional connection of the control unit 3, comprising digital circuit 17 and/or analog circuit 18, operative connection 11 and touchscreen 9 or the device 10 that has the touchscreen. The control unit 3 is preferably used for generating electrical signals that are routed via the conductor track 5 to the conductive area 4. The operative connection 11 between conductive area 4 and at least one sensor line 13 of the touchscreen 9 is used to transmit the electrical signals to the touchscreen 9 or the device 10 that has the touchscreen, which touchscreen or device that has the touchscreen interprets the signals as touch inputs. For the purpose of better illustration, this view has dispensed with the electrically conductive area 4, the electrically nonconductive substrate, the conductor track 5 and the sensor line 13. Alternatively, it may also be preferred for external (arranged outside the control element) analog and digital circuits to be used, and also combinations of these.

FIG. 8 shows a block diagram of data transmission to a touchscreen by means of input means 1. As soon as the input means 1 is activated by a user, which can be done by pushing a key 19 and/or switch, for example, the control unit 3 generates data. The control unit 3 is supplied with power by the energy source 2 and can therefore operate independently. The data are converted by the control unit 3 into a serial or parallel data stream, which is in turn forwarded as an electrical signal to the electrically conductive areas 4 via the conductor tracks 5. Said areas are in operative contact with a touchscreen 9 and generate a touch input on the touchscreen 9. The touch input is preferably based on capacitive coupling 16, which can be evaluated by the evaluation unit of the touchscreen or of the device 10 that has the touchscreen. This allows authorization or authentication to take place easily and quickly by means of the input means 1. The input means 1 may be integrated in a credit card, for example, and can therefore be used as a payment means or further control element.

FIGS. 9-12 show preferred embodiments of the input means. The input means may be embodied in different ways. By way of example, it may be shaped as a card or else as a voluminous body, which means that the fields of application of the input means are almost unlimited. By way of example, it can be used as a playing piece by virtue of it having the shape of a playing piece in a game. This may be advantageous particularly when the playing piece is intended to be used to enable a digital content, for example. By way of example, a player who has acquired the piece in the game can bring an electronic device having a touchscreen into contact with the playing piece and enable digital contents, such as vouchers.

For this, the piece preferably has electrically conductive regions or areas (electrodes 4) that are controlled by a control unit 3 after the piece has been activated by a user. This prompts one or more touch events on the touchscreen, as a result of which an action or an event is initiated on the touchscreen or in the electrical device. The playing piece has particularly one or more pushbutton switches 19, conductor tracks 5, at least one energy source 2, at least one control unit 3 and at least one electrode 4. It goes without saying that the arrangement of the parts can be matched to the size and shape of a playing piece and is indicated only by way of example in the figures. FIGS. 9-12 are intended to be used to demonstrate that the input means can be embodied not only as a card but also as a voluminous body and is therefore universally usable.

FIG. 13 and FIG. 14 show a static and dynamic input on the touchscreen using the input means. The data input on the touchscreen can be made statically and/or dynamically. In particular, a static input denotes precisely one state from a combination of the touch points within the context of a snapshot, as shown by way of example in FIG. 13A. A chronology of various static states characterizes a dynamic input, in particular. An example of a sequence for a dynamic input is shown by figures A-C in FIG. 13. The touch points 23 generated chronologically by the input means 1 undergo change, as a result of which a dynamic data input is made. A static and/or dynamic data input can also be made as shown in FIG. 14. A user 21 brings the input means 1 into operative contact with a touchscreen 9, wherein he draws the input means 1 over the touchscreen 9, for example.

### LIST OF REFERENCE SYMBOLS

1 Input means
2 Energy source
3 Control unit
4 Conductive area
5 Conductor track
6 Electrically nonconductive substrate
7 Top ply
8 Intermediate ply
9 Touchscreen
10 Device having touchscreen
11 Operative connection between touchscreen and input means
12 Surface of the touchscreen
13 Sensor line of the touchscreen
14 Electrical field lines
15 Driver line of the touchscreen
16 Capacitive coupling
17 Digital circuit of the control unit
18 Analog circuit of the control unit
19 Pushbutton switch/switch
20 Playing piece
21 User
22 Solar cell
23 Generated touch points

1. An input device, comprising at least:
a. an electrically nonconductive substrate,
b. an electrically conductive area that is present on the substrate,
c. an electrical conductor track,
d. a control unit for electrically interconnecting areas according to b. and
e. an energy source,
wherein:
at least one electrically conductive area is electrically connected to the control unit via at least one conductor track.

2. The input device as claimed in claim 1,
wherein:
the areas are arranged on the substrate individually, in pairs or in functional groups.

3. The input device as claimed in claim 1,
wherein:
the input device has at least one layer and/or at least one further substrate ply.

4. The input device as claimed in claim 1,
wherein:
the control unit comprises at least one digital and/or analog circuit.

5. The input device as claimed in claim 4,
wherein:
the at least one circuit of the control unit is an electronic, electromechanical or mechanical circuit.

6. The input device as claimed in claim 1,
wherein:
the energy source is a battery, a storage battery, a solar cell, a piezo element, a capacitor or a combination of these.

7. The input device means as claimed in claim 1,
wherein:
the input device comprises at least one key and/or a switch.

8. A system comprising the input device as claimed in claim 1, in combination with a touchscreen,
wherein:
the touchscreen is operatively connected to the input device.

9. The system as claimed in claim 8,
wherein:
the input device is connected to the touchscreen via a form-fit, force-fit and/or integral connection or is held thereon by gravitational force.

10. The system as claimed in claim 8,
wherein:
the touchscreen has visual, audible, tactile, haptic or mechanical positioning means.

11. A method comprising:
inputting data on a touchscreen using an input device, the input device comprising at least:
i. an electrically nonconductive substrate,
ii. an electrically conductive area that is present on the substrate,
iii. an electrical conductor track,
iv. a control unit,
v. an energy source,
vi. and/or a key and/or a switch,
wherein at least one electrically conductive area is electrically connected to the control unit via at least one conductor track, and
wherein the input device is operatively connected to the touchscreen, as a result of which the areas begin to interact with the touchscreen, as a result of which, for electrically activated areas, influencing of touch events is achieved and data input on the touchscreen is attained.

12. The method as claimed in claim 11, wherein the input data are randomly produced or determined data.

13. The method as claimed in claim 11, wherein the data input on the touchscreen is effected statically and/or dynamically.

14. The method as claimed in claim 11, wherein the input device is used to input data on the touchscreen for authentication and/or authorization.

15. The method as claimed in claim 14, wherein a one-time password, password or code is generated.

16. The method as claimed in claim 14, wherein the input device is a card for paying for goods and services or is integrated in such a card.

17. The method as claimed in claim 11, wherein the input device is used to input data on the touchscreen for applications selected from a group consisting of: playing pieces, identification, customer cards, engine immobilizer, access authorization for car/bike sharing, entry authorization, random number generator, chip cards, car keys, keys, playing cards, collectable cards, goods logistics, goods tracking, digital classification systems, cataloging, digital file card system, admission, entry tickets, access to locked regions both really and virtually, virtual contents, marketing applications, customer loyalty, lotteries and competitions, member identity cards, season tickets, payment applications, certificates of authenticity, certificates, forgery safeguards, copy protections, signatures, delivery notes, articles within computer games, music/video/e-book downloads, bonus stamps/programs, device controllers and gift cards.
